(19) United States
(12) Patent Application Publication
(10) Pub. No.: US 2026/0241644 A1
(43) Pub. Date: Aug. 20, 2026

(54) METHOD FOR PRODUCING COMPOSITE FIBER MATERIALS WITH A PARTICULARLY LOW DEGREE OF FIBER WARPAGE

(71) Applicant: BOND-LAMINATES GMBH, Brilon (DE)

(72) Inventor: Stefan SEIDEL, Brilon (DE)

(21) Appl. No.: 18/870,260

(22) PCT Filed: Nov. 25, 2022
(86) PCT No.: PCT/EP2022/083334

§ 371 Date: Nov. 27, 2024

(30) Foreign Application Priority Data
May 30, 2022 (EP) 22176056.4

(51) Int. Cl. B29C 70/22; B29C 70/00; B29C 70/50; B29K 23/00; B29K 105/08; B29K 309/08

(52) U.S. Cl. CPC B29C 70/22; B29C 70/003; B29C 70/504; B29K 2023/12; B29K 2105/0845; B29K 2309/08

(57) ABSTRACT

The invention relates to a method for producing fiber composite materials comprising a thermoplastic molding composition A and at least one layer of reinforcing fibers B. The thermoplastic molding composition A is embedded into the at least one layer of reinforcing fibers B as a matrix, wherein the embedding is realized by moving the molding composition relative to the reinforcing fibers B within a consolidating step, in which the reinforcing fibers B remain immobile except for a one-dimensional production advancing movement, the thermoplastic molding composition A has at least one chemically reactive functionality, and the surface of the reinforcing fibers B is treated with a sizing, and the concentration of functional groups for the chemically reactive functionalities of the molding composition A is at least 0.3 mol %.

The present invention relates to a process for producing fiber composite materials comprising a thermoplastic molding composition A and at least one ply of reinforcing fibers B, wherein the thermoplastic molding composition A as matrix is embedded into the at least one ply of reinforcing fibers B, wherein the embedding takes place by virtue of a relative movement of the molding composition with respect to the reinforcing fibers B within a consolidation step in which the reinforcing fibers B remain immobile apart from a one-dimensional production feed, and the thermoplastic molding composition A has at least one chemically reactive functionality and the surface of the reinforcing fibers B has been treated with a size and the concentration of functional groups for the chemically reactive functionalities of the molding composition A is at least 0.3 mol %.

Fiber composite materials, also referred to as organosheets in flat or two-dimensional form, have a thermoplastic polymer matrix in which there are embedded one or more fiber weaves and/or one or more fiber scrims. The fibers used for production of fiber composite materials are typically glass fibers, aramid fibers or carbon fibers, which are introduced into the thermoplastic polymer matrix as continuous fibers or long fibers. The fiber length of the long fibers is in the range from 1 to 50 mm here; fibers longer than 50 mm are referred to as continuous fibers. Fiber composite materials based on continuous fibers have the highest stiffness and strength values by comparison with fiber composite materials having shorter fibers.

Fiber composite materials are usually based on a multitude of reinforcing fibers embedded in a polymer matrix. Fiber composite materials have various fields of use. Fiber composite materials are used with preference in the automotive and aviation sectors. In this field of application, the reinforcing fibers are intended to prevent tearing or other fragmentation of the polymer matrix in order thus to reduce the risk of accident resulting from component shredding. Many fiber composite materials are capable of absorbing comparatively high forces under load before there is total failure. At the same time, fiber composite materials are notable for high strength and stiffness compared to conventional unreinforced materials with simultaneously low density and other advantageous properties, in particular good aging and corrosion resistance.

Another advantage of fiber composite materials is that strength and stiffness of the fiber composite materials are adaptable to the direction and type of load. In this context, it is primarily the reinforcing fibers that are responsible for the strength and for the stiffness of a fiber composite material. In addition, the arrangement of the fibers in the fiber composite material determines the mechanical properties thereof. The matrix in turn, by contrast, usually serves primarily for introduction of the forces to be absorbed into the individual reinforcing fibers and for retention of the spatial arrangement of the reinforcing fibers in the desired orientation. In order to assure optimized transmission of force, the reinforcing fibers should be as straight as possible, i.e. without distortion in the polymer matrix. Since both the reinforcing fibers and the matrix materials are variable, numerous possible combinations of reinforcing fibers and matrix materials are available to the person skilled in the art in the production of fiber composite materials.

One technical challenge is that, in the event of total failure, a fiber composite material can undergo brittle fracture, meaning that total failure can give rise to splinters that can depart from the fracture site at high speeds. Consequently, a considerable risk of accident may arise from fiber composite material-based products that are subject to high or abrupt stress if they break up or shatter.

It is therefore desirable to provide fiber composite materials having a broad stress range in which total failure is unlikely. What are additionally desired are good optical properties, and the possibility of using the fiber composite materials to produce various elements having smooth surfaces.

EP 1 923 420 B1 describes fiber composite materials having a matrix composed of thermoplastic plastic in which there are embedded layers of reinforcing fibers. A first group of reinforcing fibers is coupled to the matrix via a first fiber-matrix adhesion. A second group of reinforcing fibers is likewise coupled to the matrix via a second fiber-matrix adhesion. This second fiber-matrix adhesion is lower than the first fiber-matrix adhesion. Different fiber-matrix adhesions achieve improved fracture characteristics in the event of total failure. Matrix materials proposed in EP 1 923 420 B1 are thermosets such as polyesters, and the thermoplastics polyamide and polypropylene.

EP 1 923 420 B1 therefore focuses, in the production of fiber composite materials, on the bonding of reinforcing fibers and polymer matrix, called fiber-matrix adhesion.

For optimization of fiber-matrix adhesion and in order to compensate for “low chemical similarity” between the reinforcing fiber surfaces and the surrounding polymer matrix, reinforcing fibers are regularly subjected to pre-treatment. What are called sizes have been found to be useful for this purpose, and what are called adhesion promoters are preferably added to these. A size or size/adhesion promoter is regularly applied to the reinforcing fiber even during the production of fibers in order to improve the further processibility thereof, especially by weaving, laying or stitching. If the size is unwanted for the later further processing of reinforcing fibers, it must first be removed in an additional process step, preferably by burndown.

But it may also be advantageous, in addition to the size, to apply an adhesion promoter to reinforcing fibers to be processed in an additional process step. Size and/or adhesion promoters form a layer on the surface of reinforcing fibers that can significantly determine the interaction of the reinforcing fibers with the environment. There is nowadays a multitude of different sizes and adhesion promoters available. Depending on the field of use, the matrix to be used and the reinforcing fibers to be used, the person skilled in the art is able to select a suitable size and a suitable adhesion promoter which is compatible with the matrix and with the reinforcing fibers.

WO 2016/170131 A1 teaches the use of a fiber composite material W with sandwich structure, formed from A) a thermoplastic layer w containing, as components, a) a thermoplastic molding composition A as matrix, b) a ply of reinforcing fibers B, and c) optionally additive C, wherein the reinforcing fiber ply B is embedded into the matrix of the thermoplastic molding composition A and the thermoplastic molding composition A in the production of the material layer w has at least one chemically reactive functionality which reacts in turn with chemical groups on the surface of the reinforcing fibers B; and B) a further thermoplastic layer T and/or a foam layer S, where the further layer T and/or S is permanently bonded to the material layer w and hence leads to elevated mechanical stability of shaped articles to be produced therefrom.

DE 10 2016 102081 A1 relates to a process for producing a fiber-reinforced component, comprising the steps of: laying fibers (16) into a casting mold (10) having a movable insert (12), pouring a matrix material (22) into the casting mold (10) and, on injection of the matrix material (22), moving the insert (12) in a movement direction (B). DE 10 2016 102081 A1 envisages that the fibers (16), prior to injection of the matrix material (22), are introduced in a direction transverse to the direction of movement (B) relative to the insert (12).

EP 3 286 258 B1 describes a process for producing fiber composite materials comprising a thermoplastic molding composition A and at least one ply of reinforcing fibers B, wherein the at least one ply of reinforcing fibers B is embedded into the matrix comprising the thermoplastic molding composition A and wherein the thermoplastic molding composition A has at least one chemically reactive functionality, the surface of the reinforcing fibers B is treated with a silane size, and the concentration of functional groups for the chemically reactive functionality is at least 0.3 mol %. EP 3 286 258 B1 does not take account of the fiber distortion that occurs in the production of fiber composite materials. This is not prevented by the process described in EP 3 286 258 B1.

WO 2016 170104 A1 relates to the use of a thermoplastic fiber composite material containing a) at least one thermoplastic molding composition A as matrix, b) at least one layer of reinforcing fibers B) and c) optionally at least one additive C, wherein at least one layer of reinforcing fibers B is embedded into the matrix of the thermoplastic molding composition and the thermoplastic molding composition A has at least one chemically reactive functionality which, during the production process of the fiber composite, reacts with chemical groups on the surface of component B material for the production of white goods such as domestic appliances, which enables lightweight products.

Reinforcing fibers, especially glass fibers, are frequently treated with a sizing in the prior art in order to protect the reinforcing fibers from each other in the event of mutual friction. For instance, DE-A 2160778 discloses glass fiber-reinforced styrene polymers based on size-treated reinforcing fibers. Mutual damage by abrasion is said to be prevented, and in the case of mutual mechanical interaction, there is said to be no cross-fragmentation (fracturing).

By means of a size, it is additionally possible to facilitate the cutting operation for reinforcing fibers in order to obtain equal stack lengths. In addition, a size can prevent agglomeration of the reinforcing fibers. The dispersibility of short fibers in water can be improved by means of a size, which makes it possible to obtain uniform fabrics by the wet laying method.

A size can also contribute to establishment of improved integrity between glass fibers and polymer matrix, in which the glass fibers act as reinforcing fibers. This principle is employed particularly in the case of glass fiber-reinforced plastics (GFRP).

In addition to the adhesion promoters as already mentioned, the sizes to be used for glass fibers preferably contain a large number of other constituents, more preferably film formers, lubricants or wetting agents.

Film formers protect glass fibers or glass filaments from mutual friction and may additionally boost affinity for synthetic resins in order thus to promote strength and integrity of a glass fiber-based fiber composite material. Film formers to be used with preference are starch derivatives, polymers and copolymers of vinyl acetate and acrylic esters, epoxy resin emulsions, polyurethane resins and polyamides. Film formers are preferably used in a proportion of 0.5% to 12% by weight, based on the overall size.

Lubricants impart suppleness to glass fibers and to the products based on glass fibers, especially weaves, and reduce mutual friction of the glass fibers with one another and against one another. It is often the case, however, that adhesion between glass fiber and synthetic resin is impaired by the use of lubricants. Lubricants used are preferably greases, oils or polyalkyleneamines. These lubricants are preferably used in an amount in the range from 0.01% to 1% by weight, based on the overall size.

Wetting agents result in lowering of surface tension and improved wetting of the glass fibers or glass filaments with the size. For aqueous sizes, poly-fatty acid amides in an amount of 0.1% to 1.5% by weight, based on the overall size, should preferably be referred to as wetting agents.

Adhesion of polymers on the reinforcing fiber surfaces is preferably improved using organofunctional silanes as adhesion promoters. Organofunctional silanes to be used with particular preference as adhesion promoters are aminopropyltriethoxysilane, methacryloyloxypropyltrimethoxysilane, or glycidyloxypropyltrimethoxysilane. These silanes that are added to an aqueous size are usually hydrolyzed to silanols here. These silanols can then react with reactive reinforcing fiber surfaces and hence form an adhesive layer, preferably with a thickness of about 3 nm.

In the case of use of glass fibers as reinforcing fibers, it is then possible for low molecular weight functional agents from the matrix polymer to react with the silanol groups on the glass fiber surface, where these low molecular weight agents then react further (especially in epoxy resins) and in so doing ensure chemical binding of the glass fiber to the polymer matrix. However, such a process is time-consuming and takes roughly between 30 minutes to more than one hour before the polymers have fully cured (especially the abovementioned epoxy resins).

Also known is functionalization of the silane size by reaction with polymers. By functionalization of low molecular weight polycarbonate types, it is possible to efficiently impregnate glass fiber weave or glass fiber scrim with polycarbonate and to bring about “grafting” by reaction of the functional groups in the polycarbonate with the glass fiber surface. However, such a process has the disadvantage of not being generally applicable to polycarbonate (PC). Only polycarbonate of low molecular weight, i.e. low viscosity, is usable in this way, and this in turn has extremely poor suitability for use and low resistance to agents that trigger stress cracking, in particular polar solvents.

Proceeding from the prior art, it is thus an object of the present invention to provide a process for producing reinforcing fiber weave-based fiber composite materials, as a result of which the fiber composite material and shaped body to be produced therefrom has improved properties, especially with regard to its flexural strength, compared to the prior art cited above, but based on the same matrix polymer.

The fiber composite material to be produced in accordance with the invention and shaped body to be produced therefrom is to be based on a firm composite (quantifiable by its flexural strength) of reinforcing fiber weave and matrix polymer which is easy to process, largely inert to conventional solvents and has good stress cracking resistance, and to have minimum fiber distortion.

Fiber distortion in the context of the present invention means any variance from the ideal weave form defined in DIN ISO 9354. In an ideal weave to be used as fabric F in accordance with the invention, the fibers are ideally in parallel and stretched form, usually with use of continuous fibers. Low fiber distortion or free of distortion in the context the present invention means that the variance of the centerline of a fiber relative to the filament length in the two-dimensional projection of the glass fiber weave in the plane of the weave is not more than 15%.

Glass fiber weaves to be used as fabric F in accordance with the invention can never be produced in ideal form by physical and technical means. They are the result of the weaving of continuous fibers, especially the weaving of rovings. The weaving of glass fibers is inevitably associated with undulation of the fibers. Undulation has the particular effect of lowering of compressive strength parallel to the fiber. It is a feature of undulation that the fibers, in relation to the plane of the fabric F, alternately move upward and downward and hence are not in ideally parallel and stretched form. Considering the two-dimensional projection of an undulating fabric, the fibers are in ideal and stretched form in the direction of the warp and weft direction of the weave. Ideal parallelism is crucial for optimal transmission of force in the fibers. If a thermoplastic polymer matrix is embedded into the fabric F in accordance with the invention, ideal parallelism of the fibers can be maintained. Variance from ideal parallelism is referred to as fiber distortion and is measured according to DIN EN ISO 13015 by visual monitoring, for example with the aid of suitable gauges or camera-based systems. The position of the fiber centerline is determined in main orientation relative to the filament length. A filament defines a bundle of fibers, which is also referred to as a roving, yarn, fiber bundle or filament bundle.

The invention provides a process for producing a fiber composite material comprising a thermoplastic molding composition A as polymer matrix M, reinforcing fibers B, comprising the steps of
i) providing at least one fabric F in the form of a weave composed of reinforcing fibers B treated with silane size,
ii) providing a thermoplastic molding composition A that serves as matrix M, having at least 0.3 mol %, based on component A, of a chemically reactive functionality in the form of functional monomers,
iii) optionally incorporating at least one additive C into the thermoplastic molding composition A,
iv) introducing the thermoplastic molding composition A that serves as matrix M into the at least one fabric F by embedding the thermoplastic molding composition A into the reinforcing fibers B by means of a relative movement in which the reinforcing fibers B remain immobile apart from a continuous or discontinuous one-dimensional production feed, and consolidating this composite composed of at least one fabric F and the matrix M,
v) reacting the chemically reactive functionalities of the thermoplastic molding composition A with the polar groups at the surface of the reinforcing fibers B that have been treated with a silane size,
vi) cooling the fiber composite material, and optionally further process steps,
wherein the chemically reactive functionality of the thermoplastic molding composition A is based on components selected from the group consisting of maleic anhydride, N-phenylmaleimide and glycidyl (meth)acrylate, and steps iv) to vi) are conducted at a temperature of at least 150° C., and steps v) to vi) by pressing under elevated pressure.

The process of the invention surprisingly affords a particularly distortion-free fiber composite material.

One peculiarity of the process of the invention is the introduction of the matrix M into the at least one fabric F. The matrix M flows here into the interstices of the reinforcing fibers B treated with a silane size. Excess size is displaced here from the rovings, yarns, fiber bundles or filament bundles of the reinforcing fibers B. The fiber composite material to be produced in accordance with the invention is characterized by complete ensheathing of all individual fibers with the matrix M. This creates both optimized fiber-matrix adhesion and improved fixing of the reinforcing fibers in their spatial alignment, as a result of which a fiber composite material to be produced in accordance with the invention has lower distortion compared to a fiber composite material to be produced according to the prior art described above.

The matrix M is preferably introduced into the at least one fabric F in process step iv) via melting of the thermoplastic molding composition A and contacting thereof with at least one fabric F composed of reinforcing fibers B, as provided in process step i).

The melting of the thermoplastic molding composition A and the contacting of this melt with the reinforcing fibers B can be effected in any manner suitable for the purpose. In such an impregnation, the matrix M based on thermoplastic composition A is converted to a free-flowing state, and the reinforcing fibers B are wetted to form an interfacial layer.

Process steps iii), iv), v) and vi) can also be performed simultaneously. According to the invention, the at least one thermoplastic molding composition A contains at least 0.3 mol %, based on component A, of a chemically reactive functionality in the form of functional monomers. Preferably, the at least one thermoplastic molding composition A includes at least one copolymer A-1 comprising monomers A-I that enter into covalent bonds with the polar or functional groups B-I of the reinforcing fibers B. Immediately on contacting of the at least one thermoplastic molding composition A with the reinforcing fibers B, in the case of simultaneous performance of process steps iv), v) and vi), a chemical reaction occurs, in which the monomers A-I form a covalent bond with the surface of the reinforcing fibers B (generally via a bond to the functional groups B-I). This is preferably an esterification, especially an esterification of maleic anhydride monomers with silanol groups in a reinforcing fiber. Alternatively, the formation of a covalent bond can also be initiated in a separate step, especially by increasing the temperature, by means of free-radical initiators or by photoinitiation or a combination of these methods. This can be implemented at any suitable temperature.

Steps iv) to vi) are conducted at a temperature of at least 150° C., preferably of at least 175° C., more preferably of at least 200° C., especially preferably within a range from 230° C. to 300° C. It should preferably be ensured here that as little pyrolysis as possible occurs, and the reactants used and the components used are not subject to thermal breakdown.

In a preferred embodiment, in the performance of steps iv) to vi), the dwell time at temperatures of ≥200° C. is not more than 10 min, preferably not more than 5 min, more preferably not more than 2 min, especially preferably not more than 1 min. It is often the case that 1 to 60 seconds is sufficient for process steps iv) to vi) and the thermal treatment that occurs therein.

The process, especially steps iv) to vi), can in principle be conducted at any pressure. Process steps v) and vi) are preferably conducted at elevated pressure, which can improve the properties of the fiber composite material to be produced. In particular, it was surprisingly possible to improve the appearance of the surface in this way. Experiments in the context of the present invention showed that, especially when process step vi) is not conducted at elevated pressure, there was an increase in surface roughness and the proportion of inclusions of air in the fiber composite material.

In a preferred embodiment, therefore, process steps iv) to vi) are conducted at a pressure in the range from 5 to 100 bar and a pressing time in the range from 1 to 60 s, more preferably at a pressure in the range from 10 to 30 bar and a pressing time in the range from 2 to 40 s.

Polypropylenes provided with at least one chemically reactive functionality (A-I) are preferably used as thermoplastic molding composition A in the matrix M. The use of amorphous thermoplastics, especially styrene copolymers or polycarbonates, can significantly increase the surface quality of the fiber composite materials to be manufactured since the lower shrinkage of the amorphous thermoplastics improves surface topology, owing to the fiber-rich (crossing point in fabrics) and fiber-poor regions, by comparison with semicrystalline thermoplastics. If process step vi) is conducted at elevated pressure in accordance with the invention, comparable surface quality is surprisingly also achievable with semicrystalline thermoplastics.

In process step v) and especially during the consolidation in process step vi), the relative movement of the thermoplastic molding composition A in relation to the reinforcing fibers B displaces the air present between the reinforcing fibers, which reduces inclusions of air in the fiber composite material to composition manufactured and establishes a good bond between thermoplastic molding composition A and reinforcing fibers B. It is a preferred aim of the present invention to obtain a (very substantially) pore-free material composite after impregnation and consolidation. What is meant by “pore-free” in the context of the present invention is when a fiber composite material contains less than 5% by volume of air or vacuoles, which can be detected by optical test methods, x-ray imaging, density measurements or ashing, especially according to ASTM D2734-09.

Alternatively, the process steps may be executed in a separate sequence. For example, it is thus possible to prepare plies of reinforcing fibers B with differently prepared reinforcing fibers B, where impregnation of the reinforcing fibers B with the matrix M of thermoplastic molding composition A takes place. Thereafter, impregnated plies with reinforcing fibers B having different fiber-matrix adhesion may be present, which can be consolidated in a further step to give a material composite as fiber composite material. Before the plies of reinforcing fibers B are laminated with the matrix M of thermoplastic molding composition A, it is possible for at least some of the reinforcing fibers B to be subjected to a pretreatment, in the course of which the later fiber-matrix adhesion is influenced. The pretreatment may preferably comprise a coating step, an etching step, a heat treatment step or a mechanical surface treatment step. In particular, however, it is also possible to partly remove an adhesion promoter already applied by heating a portion of the reinforcing fibers B.

The reinforcing fiber plies may be bonded completely to one another in the course of the production process of the invention, which is referred to as laminating. Such fiber composite material mats offer improved strength and stiffness in reinforcing fiber direction and can particularly advantageously be processed further.

### Particularly Preferred Embodiments and Reactants in the Process

### Process step i)

The at least one fabric F to be provided in method step i) is preferably based on fabric composed of continuous fibers, including fibers that are the product of individual fiber twisting. In the case of reinforcing fibers, especially glass fibers, according to “http://de.wikipedia.org/wiki/Faser-Kunststoff-Verbund”, chopped fibers, also referred to as short fibers, having a length in the range from 0.1 to 1 mm are distinguished from long fibers having a length in the range from 1 to 50 mm and continuous fibers having a length L>50 mm.

The reinforcing fibers F that have been processed to fabrics are therefore, in accordance with the invention, preferably not short fibers (“chopped fibers”); the fiber composite material to be produced in accordance with the invention is therefore preferably not a short fiber-reinforced fiber composite material. Preferably in accordance with the invention, at least 50% of the reinforcing fibers B have a length of at least 5 mm, more preferably at least 10 mm or more than 100 mm, where the length of the reinforcing fibers B also depends on the size of the shaped article T to be produced from the fiber composite material F.

Fabric to be used in accordance with the invention in process step i) is preferably based on continuous fibers that are in the form of a roving, yarn, fiber bundle or filament bundle prior to processing to give the fabric. Particular preference is therefore given to using roving fabric, yarn fabric or filament fabric.

Preference is given to using the fabric to be used as fabric F in process step i). In a preferred embodiment, the subject matter of the present invention therefore also encompasses a process for producing a fiber composite material having a layer structure and at least two layers of weaves in the fabric F.

The layers may preferably be identically or differently constructed. In a preferred embodiment, the invention therefore relates to a process for producing a fiber composite material which is of layered construction and contains more than two, preferably more than three, weave layers. Preferably, all layers may be identically constructed, or some of the layers may be differently constructed, where “differently” refers to the weave type, to the weave pattern and to the weave materials. The way in which warp threads alternate with weft threads, and the distances at which they run below or above one another, determine the pattern of a weave.

A fiber composite material to be produced by the process of the invention is permeated, preferably largely permeated, by at least one fabric F. What is meant here by “largely permeated” is that the at least one fabric F permeates through more than 50%, preferably at least 70%, especially at least 90%, of the length of the fiber composite material to be produced in accordance with the invention. The length of the fiber composite material here is the greatest extent in any of the three spatial directions. More preferably, the at least one fabric F permeates more than 50%, even more preferably at least 70%, especially preferably at least 90%, of the area of the fiber composite material to be produced by the process of the invention. The area here is the area of the greatest extent in two of the three spatial directions.

The process of the invention preferably produces flat or two-dimensional fiber composite materials. In the case of flat or two-dimensional fiber composite materials that are preferred in accordance with the invention, the filament centerline of the individual filaments of a fabric F or of the continuous fibers to be used for the fabric runs within a window having a height of ≤15%, preferably not more than ≤10%, especially not more than $5%, along the length of the two-dimensional fiber composite material.

The flatness of a fiber composite material to be produced in accordance with the invention is determined via its thickness. A fiber composite material is flat for the purposes of the present invention when the thickness of a 300 mm×300 mm sheet of the fiber composite material does not differ by more than 10% from the average sheet thickness at any point, where the sheet thickness is measured at at least 4 points more than 100 mm from one another using a thickness gauge with a flat measurement head. In the case of smaller plate dimensions, a fiber composite material is considered to be flat for the purposes of the present invention when the limits mentioned are scaled using the ratio of the smaller plate dimensions to the plate dimensions of 300 mm×300 mm and measured by the same test methodology.

Preferably, the at least one fabric F to be provided in process step i) is based on at least one fabric composed of reinforcing fibers B treated with a silane size. More preferably, reinforcing fibers B used are glass fibers having silane groups at the surface as chemically reactive functionality.

The invention most preferably provides, in process step i), at least one fabric F based on at least one fabric composed of glass fibers having silanol groups at the surface as chemically reactive functionality.

Preferably, based on 100 parts by mass of the fiber composite material to be manufactured by the process of the invention, 5 to 80 parts by mass, more preferably 10 to 75 parts by mass, even more preferably 20 to 70 parts by mass, in particular 25 to 68 parts by mass, of reinforcing fibers B are used.

The reinforcing fibers B are used in the form of fabric F. The reinforcing fibers B may be any fiber having a surface having functional groups B-I that can enter into a covalent bond with the monomers A-I of component A.

As is well known, the physicochemical properties of reinforcing fiber-based fiber composite materials, especially glass fiber-based fiber composite materials, and resins are influenced by the affinity, the adhesion, and consequently the shear strength at the phase boundary of reinforcing fibers or glass fibers and polymer matrix. The function of a size is both to establish a compatible bond between reinforcing fibers, especially glass fibers, and the surrounding resin and to assure producibility and processibility of a roving or preliminary yarn.

Reinforcing fibers, especially glass fibers, irrespective of their chemical composition, are sensitive to creasing and scouring. Even during the fiber drawing process, it is therefore necessary to take precautions by application of size in order to protect reinforcing fibers are glass fibers against the scouring effect of glass on glass and hence to protect them from the risk of mechanical damage.

The composition of a size affects not only the degree of integrity, hardness, stiffness or surface characteristics of reinforcing fiber- or glass fiber-based products, especially weaves, but also technological processes, for example the fiber drawing process (fiber tension), winding (package build) and the drying process (drying temperature, drying time), and especially further processibility.

Sizes for reinforcing fibers, especially glass fibers, consists predominantly of one or more film formers, a lubricant, a wetting agent and one or more adhesion promoters (coupling agents). A film former imparts the required integrity to the overall filament, especially a roving, protects the glass filaments from mutual friction and can contribute to affinity for the synthetic resin and hence to the strength of a fiber composite material to be manufactured in accordance with the invention. By virtue of the dissolution of the film former layer in the matrix by possible chemical reactions with a polymer matrix, it is possible to increase adhesion and shear strength at the phase boundary of reinforcing fibers or glass fibers and synthetic resin and consequently the strength and toughness of a composite material.

Film formers used are preferably starch derivatives, polymers and copolymers of vinyl acetate and acrylic esters, epoxy resin emulsions, epoxy polyester resins (see: EP-A-0 027 942), polyurethane resins, polyolefin resins or mixed emulsions of polyvinylacetate and polystyrene in amounts in the range from 0.1 to 12.0 parts by mass based on 100 parts by mass of the overall size.

A lubricant in the size imparts the necessary suppleness to the product, especially a textile glass roving to be treated therewith, and lowers the mutual friction of the reinforcing fibers, preferably the glass fibers, both during the production thereof and during further processing, especially by weaving. However, many lubricants in peer adhesion between reinforcing fibers, especially glass fibers, and resin. Lubricants used are especially greases, oils, waxes or polyalkyleneamines in an amount in the range from 0.01 to 1.0 part by mass, based on 100 parts by mass of the overall size.

A wetting agent as size component lowers the surface tension of water and improves the wetting of reinforcing fibers, preferably glass fibers, with the size. Wetting agents used in the aqueous size, which is preferably in the form of an emulsion, are especially poly(fatty acid amides) in an amount in the range from 0.1 to 1.5 parts by mass, based on 100 parts by mass of the overall size.

Most polymers to be used as matrix have only low affinity, if any, for glass and hence for the glass fibers to be used with preference in accordance with the invention as reinforcing fibers. Adhesion promoters create a bridge between glass fiber and polymer that enables complete transmission of force in the fiber composite material or composite. Adhesion promoters increase the adhesion of polymers at the glass surface. Adhesion promoters used with preference in accordance with the invention are organofunctional silanes, especially γ-aminopropyltriethoxysilane, γ-methacryloyloxy-propyltrimethoxysilane, γ-glycidyloxypropyltrimethoxysilane. In the case of glass fibers, these adhesion promoters are preferably used in the size in amounts in the range from 0 to 1.0 parts by mass, based on 100 parts by mass of the overall size.

Before the silanes to be used as adhesion promoter are added to the aqueous size, they are preferably hydrolyzed to silanols. Such a hydrolyzate solution is only of limited stability and has a tendency to condensation. Adhesion promoter-containing layers, called polymer sizes, may contain still other additions, preferably primers, antistats or emulsifiers, which are intended to achieve specific effects.

The auxiliary components to be used in sizes are common knowledge and are described, for example, in K. L. Löwenstein—The Manufacturing Technology of Continuous Glass Fibres, Elsevier Scientific Publishing Corp. Amsterdam—Oxford—New York, 1983.

According to the invention, the surface of the reinforcing fibers B to be used, especially glass fibers, has been treated with a silane size. This size serves as lubricant particularly in the weaving of the reinforcing fibers B or glass fibers and can optionally be removed chemically after the weaving. Reinforcing fibers B used are more preferably glass fibers having hydroxy groups in the form of silanol groups as chemically reactive functionality B-I at their surface.

In one embodiment, the surface of the reinforcing fibers B or glass fibers may have further functional groups B-II, especially hydroxy, ester or amino groups.

The reinforcing fibers B or glass fibers may be embedded in the fiber composite material as fabric F in any orientation and arrangement. They are then not in a statistical uniform distribution in the fiber composite material to be produced in accordance with the invention, but in the form of a fabric, i.e. in planes having a greater share and having a smaller share, i.e. in the form of more or less separate plies. The starting material is preferably a laminate-like or laminar structure of the fiber composite material to be produced in accordance with the invention.

Even in the production of the reinforcing fibers B, especially glass fibers, the adhesion promoter may be applied as part of the size. However, it is also possible to provide for an additional operation of thermal desizing or another desizing operation that destroys or removes a size that has already been applied. Subsequently, it is then possible to coat the reinforcing fibers or glass fibers with a finish that contains the adhesion promoter and is matched to the respective matrix and the desired fiber-matrix adhesion. Alternatively, it is also possible to use polymer layers. In one embodiment, it is possible to use adhesion promoters matched to the matrix polymer that contain crosslinkable polythiourethane and/or polyesterurethane polymers that act as film formers, together with an aminosilane adhesion promoter.

Preference is given to finished reinforcing fibers or glass fibers, especially in the form of weaves, with modified silane sizes such as the FK 800 finish; see R&G glass filament weave plain 25 g/m² FK 800 glass weave R & G twill 1901005, from R&G Faserverbundwerkstoffe GmbH in 71111 Waldenbuch, Germany. Such weaves are very supple and barely fray when cut.

According to the invention, the fabrics F of the reinforcing fibers B take the form of a weave. The two-dimensional laminates obtainable in the inventive manner from the weaves of reinforcing fibers B preferably contain composites formed in layers from two-dimensional reinforcing fiber plies B and plies of the thermoplastic molding composition A that serves as matrix and wets and holds together these two-dimensional reinforcing fiber plies B. In a preferred embodiment, the matrix is in turn embedded in layers into the reinforcing fibers/fiber plies B and hence forms the fiber composite material to be manufactured in accordance with the invention.

Weaves to be used in accordance with the invention as fabric F are formed by the weaving of continuous fibers, especially by the weaving of rovings. The weaving of (continuous) glass fibers is inevitably associated with undulation of the (reinforcing) fibers. Undulation has the particular effect of lowering of compressive strength parallel to the fiber. It is a feature of undulation that the (reinforcing) fibers, in relation to the plane of the fabric F, alternately move upward and downward and hence are not in ideally parallel and stretched form. Considering the two-dimensional projection of an undulating fabric, the fibers are in ideal and stretched form in the direction of the warp and weft direction of the weave. Ideal parallelism is crucial for optimal transmission of force in the fibers. If the thermoplastic molding composition A that serves as matrix M is embedded into the fabric F, it is possible to maintain the ideal parallelism of the (reinforcing) fibers. Variance from ideal parallelism is referred to as fiber distortion and is measured according to DIN EN ISO 13015 by visual monitoring, in particular with the aid of suitable gauges or camera-based systems. The position of the fiber centerline is determined in main orientation relative to the filament length. A filament defines a bundle of fibers, which is also referred to as a roving, yarn, fiber bundle or filament bundle.

In a preferred embodiment, in the fiber composite material to be produced in accordance with the invention, the fiber centerline varies by not more than 15%, preferably not more than 10%, more preferably not more than 5%, based on the length of the fiber composite material or of the shaped article T produced therefrom, from the ideal linear, i.e. distortion-free, form.

Preferably, the process of the invention leads to a fiber composite material having a proportion by volume of reinforcing fibers B in the form of fabrics F, defined in accordance with DIN 1310, in the range from 25% to 65%, more preferably in the range from 30% to 55%.

Preferably, the process of the invention leads to a fiber composite material having a proportion by volume there, to be determined in accordance with ASTM D2734-09, of not more than 5%, where the remaining volume is preferably made up completely by the molding composition A.

### Process Step ii)

Process step ii) relates to the providing of a thermoplastic molding composition A in the form of a matrix M, having at least 0.3 mol %, based on component A, of a chemically reactive functionality in the form of functional monomers.

Having a chemically reactive functionality, or modified by a chemically reactive functionality, means that the (co) polymer contains monomers (as building block) that lead to reactive chemical groups in the (co) polymer.

This chemically reactive functionality reacts during the process for production of the fiber composite material to be produced in accordance with the invention with chemical groups on the surface of the reinforcing fibers B. Preference is given to using a thermoplastic molding composition A based on a (co) polymer that serves as matrix. Such a (co) polymer preferably comprises at least one functional monomer A-I, the functionality of which reacts with chemical groups on the surface of the reinforcing fibers B during the process for production of the fiber composite material. The (co) polymer comprising monomer A-I is also referred to as polymer component (A-a) in the context of the present application.

Optionally, the thermoplastic molding composition A may additionally contain one or more (co) polymers that are electively also free of such a chemically reactive functionality (and therefore do not contain a functional monomer A-I) and hence do not react with chemical groups at the surface of the reinforcing fibers B during the process for production of the fiber composite material. Such a (co) polymer is also referred to as polymer component (A-b) in the context of the present application.

Preferably, the thermoplastic molding composition A for the matrix M is based on amorphous or semicrystalline polymer. More preferably, the thermoplastic molding composition A to be used as matrix M is used in the form of a semicrystalline polymer. A solid containing both crystalline and amorphous regions (domains) is referred to as semicrystalline. If the melt of a polymer is cooled, the chains of the polymers will move to an ever lesser degree, and they will regularly begin to take on an arrangement or to crystallize. But since they are entangled, this process cannot take place throughout the melt, and can only take place in domains. In the residue of the melt, the chains will solidify in an unordered (amorphous) manner. The slower the cooling of the melt, the greater the degree of crystallization of polymers. Polymers having small side chains crystallize better than those having long side chains. Crosslinked or branched polymers, by contrast, are less likely to crystallize. According to DE 10 2011 084 519 A1, semicrystalline polyamides have an enthalpy of fusion of more than 25 J/g, measured by the DSC method to ISO 11357 in the second heating run and by integration of the melt peak, where this definition is also applicable to other semicrystalline polymers.

In process step ii), the matrix M is used in amounts such that a fiber composite material to be produced in accordance with the invention preferably 10 to 95 parts by mass, more preferably 20 to 50 parts by mass, even more preferably 23 to 40 parts by mass, and especially 27 to 38 parts by mass, of matrix M, based on 100 parts by mass of the fiber composite material, is based.

The thermoplastic molding composition A to be provided as matrix M in process step ii) is preferably based on at least one polymer from the group of polyolefins, polyamides, thermoplastic elastomers, polycarbonates, polybutadiene terephthalates, polylactides, polyphenylene sulfides and styrene copolymers.

Preferred styrene copolymers of styrene-acrylonitrile copolymers (SAN), α-methylstyrene-acrylonitrile copolymers (AMSAN), impact-modified styrene-acrylonitrile copolymers, acrylonitrile-butadiene-styrene copolymers (ABS), styrene-methyl methacrylate copolymers (SMMA), methacrylate-acrylonitrile-butadiene-styrene copolymers (MABS) or acrylic ester-styrene-acrylonitrile copolymers (ASA), where the styrene copolymers have been modified with monomers (A-I).

Blends of the aforementioned copolymers with polycarbonate or with semicrystalline polymers, especially with polyamide, are also suitable, provided that the proportion of semicrystalline mixture components in component A is less than 50% by weight.

Preferably in accordance with the invention, at least one of the polymer components in the thermoplastic molding composition A has been modified with monomer A-I (polymer component (A-a)). Any further polymer components, preferably styrene copolymers, especially those as mentioned above, that have optionally not been modified with monomer A-I may optionally additionally be present in the thermoplastic molding composition A (polymer component (A-b)).

Very particular preference is given to using SAN-(M-I) copolymers (with modification by monomers A-I) as a constituent of the thermoplastic molding composition A (optionally even as the sole polymeric constituent).

According to the invention, at least one of the (co) polymer components of the thermoplastic molding composition A is a (co) polymer having at least one chemically reactive functionality (polymer component (A-a)). Each of the copolymer components mentioned in the preceding paragraph relating to process step ii) may accordingly also have, in addition to the monomers explicitly mentioned, a reactive functionality that can react with the surface of the reinforcing fibers B during the production of the fiber composite material. It is thus possible for any of the aforementioned (co) polymers also to constitute a polymer component (A-a).

Accordingly, the aforementioned polymer components, in the use thereof as polymer component (A-a), may generally also comprise at least one monomer A-I that imparts the chemically reactive functionality (and therefore the reaction with reinforcing fibers B). In that case, these may preferably also be referred to as polystyrene (A-I) copolymer, styrene acrylonitrile (A-I) copolymer, α-methylstyrene-acrylonitrile (A-I) copolymer, impact-modified acrylonitrile-styrene (A-I) copolymer, acrylonitrile-butadiene-styrene (A-I) copolymer (ABS-(A-I)) and acrylonitrile-styrene-acrylic ester (A-I) copolymer (ASA-(A-I)). Also possible are blends of the copolymers mentioned with polycarbonate or polyamide.

It is optionally possible for the aforementioned polymer components, in the use thereof as polymer component (A-a), also to additionally comprise a second monomer (or even a third monomer) having the chemically reactive functionality.

In particular, it is therefore possible for the aforementioned polymer components (in the use thereof as polymer component (A-a)), in the case of use of maleic anhydride (MA) as monomer A-I, also to be referred to as polystyrene-maleic anhydride copolymer, styrene-acrylonitrile-maleic anhydride copolymer, α-methylstyrene-acrylonitrile-maleic anhydride copolymer, impact-modified acrylonitrile-styrene-maleic anhydride copolymer, acrylonitrile-butadiene-styrene-maleic anhydride copolymer (ABS-MA) or acrylonitrile-styrene-acrylic ester-maleic anhydride copolymer (ASA-MA). Also possible are blends of the copolymers mentioned with polycarbonate or polyamide. The same also applies to other monomers A-I.

In one embodiment, in process step ii), it is possible to use any one or more other (co) polymers without such a functionality (as polymer component (A-b)) in addition to the one or more polymer component(s) (A-a). Here too, it is preferably possible to use the aforementioned (co) polymers polystyrene, styrene-acrylonitrile copolymers, α-methylstyrene-acrylonitrile copolymers, impact-modified acrylonitrile-styrene copolymers, acrylonitrile-butadiene-styrene copolymers (ABS) and acrylonitrile-styrene-acrylic ester copolymers (ASA), and blends of the (co) polymers mentioned with polycarbonate or polyamide, but in that case without the functionality (and therefore without reactive monomer A-I).

Thermoplastic molding composition A used are more preferably polyolefins, even more preferably polypropylene (PP) or else high-pressure polyethylene (HPPE). The thermoplastic molding composition A in such a case preferably contains more than 50% polypropylene or of a copolymer (A-1). In one embodiment, such a thermoplastic molding composition A contains at least 90% copolymer A-1. The thermoplastic molding composition A in such a case may also consist solely of copolymer A-1.

Preferably in accordance with the invention, at least one of the components of the thermoplastic molding composition A contains a (co) polymer that has at least one chemically reactive functionality as described herein and is referred to as polymer component (A-a). More preferably, at least one of the aforementioned polymer components is polypropylene and/or at least one copolymer A-1 (styrene copolymer, especially SAN, SMMA, ABS and ASA) contains at least one monomer A-I.

In the especially preferred case of use of maleic anhydride (MA) as monomer A-I, polypropylene contains a polypropylene-maleic anhydride copolymer and copolymer A-1 is especially preferably styrene-acrylonitrile-maleic anhydride copolymer (SAN-MA), styrene-methyl methacrylate-maleic anhydride copolymer (SMMA-MA), acrylonitrile-butadiene-styrene-maleic anhydride copolymer (ABS-MA) or acrylic ester-styrene-acrylonitrile-maleic anhydride copolymer (ASA-MA).

It is optionally possible, in addition to the at least one polymer component (A-a), to use any one or more other (co) polymers without such a functionality as polymer component (A-b). This may preferably be polystyrene, SAN, SMMA, ABS and/or ASA (in each case not comprising any monomer A-I).

The thermoplastic molding composition A, in an alternative embodiment, is preferably an amorphous molding composition, where the amorphous state of the thermoplastic molding composition (thermoplastic) means that the macromolecules are in a completely random arrangement without regular arrangement or orientation, i.e. without equal separation.

Preferably, in such a case, the entire thermoplastic molding composition A has amorphous thermoplastic properties, and is therefore fusible and (largely) noncrystalline. As a result, the shrinkage of the thermoplastic molding composition A, and therefore of the entire fiber composite material as well, is comparatively low. It is possible to achieve particularly smooth surfaces in the molded articles T to be manufactured from the fiber composite materials to be produced in accordance with the invention.

As a preferably amorphous molding composition, component A contains a semicrystalline content of less than 50 parts by mass, more preferably less than 40 parts by mass, based on 100 parts by mass of component A. Semicrystalline thermoplastics form both chemically regular and geometric regions, i.e. there are regions in which crystallites are formed. Crystallites are parallel bundles of sections of molecules or folds of molecule chains. Individual chain molecules may pass partly through the crystalline or amorphous region. They may sometimes even belong to multiple crystallites simultaneously.

The thermoplastic molding composition A may also be a blend of amorphous thermoplastic polymers and semicrystalline polymers.

The thermoplastic molding composition A is preferably a blend of a styrene copolymer A-I, especially a blend of SAN, with one or more polycarbonate(s) and/or one or more semicrystalline polymers, especially polyamide, where the proportion of semicrystalline mixture components in component A is less than 50 parts by mass, preferably less than 40 parts by mass, relative to 100 parts by mass of the thermoplastic molding composition A.

Preferably in accordance with the invention, the at least one thermoplastic molding composition A includes at least one copolymer A-1 comprising monomers A-I that enter into covalent bonds with the functional groups B-I of the embedded reinforcing fibers B. The proportion of monomers A-I in the thermoplastic molding composition A may be chosen in a variable manner. The higher the proportion of monomers A-I and of the functional group (B-I), the stronger the bond between the thermoplastic molding composition A and the reinforcing fibers B may also be. Monomers A-I may still be present as monomers in copolymer A-1, or may be integrated into the copolymer A-1. The monomers A-I are preferably integrated into the copolymer A-1.

In a preferred embodiment, copolymer A is formed with a proportion of monomers A-I of at least 0.3 part by mass, more preferably of at least 0.5 part by mass, even more preferably of 0.5 to 5 parts by mass, especially preferably of at least 1 part by mass, very especially preferably of 1 to 5 parts by mass, based on 100 parts by mass of copolymer A.

The concentration of functional groups (chemically reactive functionality) is preferably at least 0.3 mol %, more preferably at least 0.5 mol %, even more preferably 1 mol %, especially preferably 1 to 5 mol %, based on 100 mol % of monomers that are used for production of thermoplastic molding composition A.

In a preferred embodiment, functional groups of thermoplastic molding composition A are selected from the group of the anhydride, ester, carboxyl, amide, imide, acrylate and glycidyl groups. Monomers A-I that can enter into covalent bonds with the functional groups B-I of the reinforcing fibers B include all monomers having such properties. Preferred monomers A-I here are those that can enter into covalent bonds by reaction with hydroxy or amino groups.

Monomers A-I preferably have:
(a) at least one functionality capable of entering into covalent bonds with the functional groups B-I on the surface of the reinforcing fibers B, preferably by reaction with hydroxy and/or amino groups; and
(b) at least one second functionality capable of being incorporated into copolymer A-1, preferably a double bond, more preferably a terminal double bond, which is preferably incorporated into copolymer A-1 by free-radical polymerization.

Optionally, copolymer A-1 or else another (co) polymer present in thermoplastic molding composition A may contain one or more other monomers capable of entering into covalent or noncovalent bonds with the reinforcing fibers B.

In a preferred embodiment, monomers A-I are selected from the group of maleic anhydride (MA), N-phenylmaleimide (PM), tert-butyl (meth)acrylate and glycidyl (meth)acrylate (GM). In a particularly preferred embodiment, monomers A-I are selected from the group of maleic anhydride (MA), N-phenylmaleimide (PM) and glycidyl (meth)acrylate (GM). It is also possible for two of these monomers A-I to be present in copolymer A-1.

Copolymer A-I in the thermoplastic molding composition A may optionally include further functional monomers A-II. Preferred copolymers A-1 are styrene/maleic anhydride, styrene/acrylonitrile/maleic anhydride, styrene/glycidyl methacrylate, styrene/N-phenylmaleimide, styrene/acrylonitrile/N-phenylmaleimide, methyl methacrylate/N-phenylmaleimide, methyl methacrylate/maleic anhydride, methyl methacrylate/maleic anhydride/N-phenylmaleimide, acrylonitrile/styrene/tert-butyl (meth)acrylate, acrylonitrile/butadiene/styrene/tert-butyl (meth)acrylate and acrylonitrile/butyl acrylate/styrene/tert-butyl (meth)acrylate. Particularly preferred copolymers A-I are styrene/maleic anhydride, styrene/acrylonitrile/maleic anhydride, styrene/glycidyl methacrylate, styrene/N-phenylmaleimide, styrene/acrylonitrile/N-phenylmaleimide, methyl methacrylate/N-phenylmaleimide and methyl methacrylate/maleic anhydride/N-phenylmaleimide.

The process of the invention preferably provides a thermoplastic molding composition A composed of polystyrene, especially glass-clear polystyrene “PS” or impact-resistant polystyrene or high-impact polystyrene “HIPS”. The process of the invention with glass-clear polystyrene preferably produces (partly) transmissive or transparent fiber composite materials.

In a particularly preferred embodiment, the polymer component (A-a) of the thermoplastic molding composition A to be used in accordance with the invention is based on a polypropylene. In this case, the polypropylene additionally comprises a monomer A-I that reacts with the surface of the reinforcing fibers B during the production process.

What is meant in accordance with the invention by the feature “modified by a chemically reactive functionality” or “having a chemically reactive functionality” is in particular the incorporation of maleic anhydride monomers into the polymer chain of the (co) polymer to be used in accordance with the invention.

Very particular preference is given to a process in which the chemically reactive functionality of the thermoplastic molding composition A is based on components selected from the group of maleic anhydride, N-phenylmaleimide, tert-butyl (meth)acrylate and glycidyl (meth)acrylate, especially selected from the group consisting of maleic anhydride, N-phenylmaleimide and glycidyl (meth)acrylate.

A modified polypropylene to be used especially preferably in accordance with the invention as thermoplastic molding composition A is produced from, based on 100 parts by mass of the modified polypropylene, 90 to 99.7 parts by mass of unmodified polypropylene, preferably 95 to 99 parts by mass of unmodified polypropylene, and 0.3 to 10 parts by mass, preferably 1 to 5 parts by mass, of maleic anhydride. More preferably, the maleic anhydride content in component A is in the range from 0.1 to 6 parts by mass, even more preferably in the range from 1 to 5 parts by mass, especially in the range from 3 to 4 parts by mass, based on 100 parts by mass of modified polypropylene.

Mention should also be made of mixtures of styrene-acrylonitrile copolymer with α-methylstyrene-acrylonitrile copolymer. Acrylonitrile-butadiene-styrene copolymer to be used with preference in accordance with the invention as thermoplastic molding composition A is produced by known methods from styrene, acrylonitrile, butadiene and a functional further monomer A-I, especially methyl methacrylate.

Preferably in accordance with the invention, at least one of the (co) polymer components of the thermoplastic molding composition A is a (co) polymer having at least one chemically reactive functionality as described (polymer component (A-a)). This may also be a polymer component as described above that contains at least one functional monomer A-I in the molding composition mentioned. It is optionally possible to use any one or more other (co) polymers without such a functionality (as polymer component (A-b)).

In a further preferred embodiment, the matrix M may consist of at least two different thermoplastic molding composition A. These different molding composition types may preferably feature a different melt flow index (MFI) and/or different comonomers or additives.

According to the invention, the term “molecular weight” (Mw) may be regarded in its broadest sense as the mass of a molecule or as the region of a molecule, especially a polymer strand, a block polymer or a small molecule, which can be reported in g/mol (Da) and kg/mol (kDa). The molecular weight (Mw) is preferably the weight average, which can be determined by the methods known in the prior art.

The thermoplastic molding compositions A to be used in process step ii) in accordance with the invention preferably have a molecular weight Mw in the range from 10 000 to 800 000 g/mol, more preferably in the range from 20 000 to 600 000 g/mol, where Mw can be determined by light scatter in tetrahydrofuran (GPC with UV detector). The molecular weight Mw of the thermoplastic molding compositions A may vary within a range of +/−20%. See: A. Müller, Polymer Charakterisierung [Polymer Characterization], Hanser Verlag 1996.

The thermoplastic molding composition A preferably contains a polypropylene modified by a chemically reactive functionality, which, apart from the addition of monomers A-I, is formed essentially from the same monomers as “normal polypropylene”, where the monomer content is +/−5%, the molecular weight is +/−20%, and the melt flow index determined at a temperature of 230° C. and a load of 2.16 kg according to ISO 1133 may vary by +/−20%. Preferably in accordance with the invention, ISO 1133 means DIN EN ISO 1133-1:2012-03.

In a preferred embodiment, the melt volume flow rate (MVR), measured to ISO 1133, of the thermoplastic polymer composition A to be used as polymer matrix is in the range from 0.1 to 400 cm³/10 min, more preferably in the range from 0.5 to 200 cm³/10 min, especially particular preferably in the range from 1 to 150 cm³/10 min at 230° C./2.16 kg.

In a particularly preferred embodiment, the melt volume flow rate (MVR), measured to ISO 1133, of the thermoplastic polymer composition A to be used as polymer matrix is in the range from 50 to 200 cm³/10 min, more preferably in the range from 70 to 150 cm³/10 min, especially preferably in the range from 85 to 125 cm³/10 min at 230° C./2.16 kg.

The process is particularly preferred in accordance with the invention when the thermoplastic molding composition, based on 100 parts by mass of polypropylene, additionally contains 0.1 to 6 parts by mass of maleic anhydride. Most preferably, the proportion by mass of maleic anhydride based on 100 parts by mass of polypropylene is in the range from 0.2 to 5 parts by mass, especially preferably in the range from 1 to 4 parts by mass, very especially preferably in the range from 3 to 4 parts by mass.

### Process Step iii)

Process step iii) relates to the optional incorporation of at least one additive C into the thermoplastic molding composition A that serves as matrix M. A matrix M to be used in accordance with the invention preferably contains, for 100 parts by mass of the thermoplastic molding composition A, 0.01 to 40 parts by mass of at least one additive C, more preferably 0.01 to 30 parts by mass, even more preferably 0.01 to 25 parts by mass, especially preferably 1 to 20 parts by mass, where additive C is different from the base polymer of thermoplastic molding composition A and from the reinforcing fibers B.

Additives C used are preferably particulate mineral fillers, processing aids, stabilizers, oxidation retardants, thermal decomposition retardants, ultraviolet light decomposition retardants, lubricants and demolding agents, flame retardants, dyes, pigments or plasticizers. According to the present invention, it is preferably also possible to use two or more of these additives.

Preferred particulate mineral fillers are selected from the group of amorphous silica, carbonate, especially magnesium carbonate, calcium carbonate (chalk), powdered quartz, mica, silicates, especially clays, muscovite, biotite, suzoite, tin maletite, talc, chlorite, phlogopite, feldspar and calcium silicates, especially wollastonite or kaolin. Kaolin is a very particularly preferred mineral filler.

Preferred UV stabilizers are selected from the group of substituted resorcinols, salicylates, benzotriazoles and benzophenones.

Preferred oxidation retardants, also known as thermal stabilizers, are selected from the group of the sterically hindered phenols, hydroquinones, secondary aromatic amines, optionally in combination with phosphorus acids or salts thereof, and mixtures of these compositions.

Preferred lubricants and demolding agents are selected from the group of stearic acid, stearyl alcohol, alkyl stearates, stearylamides, especially Irganox®, and esters of pentaerythritol with long-chain fatty acids. It is possible to use the calcium, zinc or aluminum salts of stearic acid, and dialkyl ketones, especially distearyl ketone. In addition, it is also possible to use ethylene oxide-propylene oxide copolymers as lubricants and demolding agents. In addition, it is possible to use natural and synthetic waxes. These include polypropylene waxes, polyethylene waxes, polyamide waxes, grafted polyolefin waxes, HDPE waxes, PTFE waxes, EBS waxes, montan wax, carnauba waxes and beeswaxes.

Flame retardants may either be halogenated or halogen-free compounds. Suitable halogen compounds, where brominated compounds are preferable over chlorinated compounds, remain stable in the production and processing of the molding compound of the invention, such that no corrosive gases are released and efficacy is not impaired thereby. Preference is given, however, to using halogen-free compounds, more preferably phosphorus compounds, especially phosphine oxides and derivatives of acids of phosphorus and salts of acids and acid derivatives of phosphorus as flame retardants. More preferably, phosphorus compounds contain ester, alkyl, cycloalkyl and/or aryl groups. Likewise suitable are oligomeric phosphorus compounds having a molecular weight of less than 2000 g/mol, as described, for example, in EP-A 0 363 608.

Pigments and dyes to be used as additives are common knowledge; see, for example, R. Gachter and H. Müller, Taschenbuch der Kunststoffadditive [Handbook of Plastics Additives], Carl Hanser Verlag, 1983, p. 494 to 510. Preferred pigments are white pigments from the group of zinc oxide, zinc sulfide, lead white, lithopone, antimony white and titanium dioxide. Of the two most common crystal modifications of titanium dioxide (the rutile and anatase types), the rutile form in particular is used for whitening of the thermoplastic molding compositions to be used in accordance with the invention.

Black color pigments that can likewise be used as additive in accordance with the invention are iron oxide black (Fe₃O₄), spinel black (Cu(Cr,Fe)₂O₄), manganese black (=mixture of manganese dioxide, silicon oxide and iron oxide), cobalt black and antimony black, and more preferably carbon black, which is usually used in the form of furnace black or gas black (in this regard see G. Benzing, Pigmente für Anstrichmittel [Pigments for Paints], Expert-Verlag (1988), p. 78ff). It is of course possible in accordance with the invention to establish particular shades using inorganic chromatic pigments such as chromium oxide green, or organic chromatic pigments, especially azo pigments and phthalocyanines. Pigments of this kind are generally commercially available. In addition, it may be advantageous to use the pigments or dyes mentioned in the mixture, especially carbon black with copper phthalocyanines, which generally facilitates color dispersion in the thermoplastics.

At least one additive C is preferably incorporated into the thermoplastic molding composition A by compounding. The compounding is in turn preferably effected in extruders, especially in corotating twin-screw extruders, counter-rotating twin-screw extruders, in planetary roll extruders or in the co-kneader. Compounding encompasses the process operations of conveying, melting, dispersing, degassing, pressure buildup and extrusion (expulsion).

### Process Steps iv) to vi)

After the optional incorporation of at least one additive C into the thermoplastic molding composition A that serves as matrix M, this is introduced into the at least one fabric F provided in process step iv).

In process step v), the chemically reactive functionalities of the thermoplastic molding composition A are reacted with the polar groups on the surface of the reinforcing fibers B that have been treated with a silane size, before the fiber composite material is cooled down in process step vi), and this is optionally followed by further process steps.

The process of the invention, especially process steps iv) and v) or optionally also process step vi), are preferably conducted on a double belt press, interval heating press or on a static press. A double belt press in particular is capable of producing, in a quasi-continuous manner, a fiber composite from powder-based or film-based thermoplastic molding composition by conversion to a melt.

The thermoplastic molding composition A that serves as matrix M is introduced into the at least one fabric F by embedding the thermoplastic molding composition A into the reinforcing fibers B by means of a relative movement in which the reinforcing fibers B remain immobile apart from a one-dimensional production feed, followed by consolidation of this composite composed of at least one fabric F and the matrix M.

The relative movement of the thermoplastic molding composition A in relation to the reinforcing fibers B displaces the air present between the reinforcing fibers F. As a result, inclusions of air in the fiber composite material are reduced and a good bond between thermoplastic molding composition A and reinforcing fibers B is prevented, especially in the case of molding composition A embedded in layers. It is preferable in accordance with the invention to obtain a (very substantially) pore-free material composite after impregnation and consolidation.

The relative movement of the thermoplastic molding composition A in relation to the reinforcing fibers B is achieved by the fixing of the reinforcing fibers B in the direction of relative movement. This fixing is created in that the fixing of the reinforcing fibers B upstream and downstream of the region in which the movement of the thermoplastic molding composition A is created by a surface pressure >10 bar at a temperature of at least 10° C. above the crystallite melting temperature or glass transition temperature in the case of amorphous thermoplastics is effected by means of mechanical clamping, winding or with the aid of securing elements, and this hold is maintained by application of opposing force under constant strain. In this way, the reinforcing fibers B are fixed in position such that the strain in longitudinal direction prevents movement in any spatial direction. If the reinforcing fibers are fixed in this way and the thermoplastic molding composition is subjected to the pressure and temperature as described above for at least 1 second, the thermoplastic molding composition is moved into the interstices between the reinforcing fibers. Once the thermoplastic molding composition has completed its movement, the reinforcing fibers are removed from the temperature and pressure region.

The reinforcing fiber remains immobile here apart from a continuous or discontinuous one-dimensional production feed. Preferably in accordance with the invention, the reinforcing fibers B in the form of weaves are fixed and kept under tension by an automatic draw system in roll form on retarded unwinding drums upstream of the region of application of temperature and pressure, and as a consolidated stack downstream of the region of application of temperature and pressure.

The consolidation that accompanies process step iv), in addition to the one-dimensional production feed, is crucial to the process of the invention. The consolidation in the broader sense is a bonding process in which physical processes lead to development of strength at the join of matrix M with the at least one fabric F. In principle, there are four main mechanisms that proceed in the course of consolidation: (if appropriate) impregnation of the fibers, laminate consolidation, molecular penetration, and solidification.

The impregnation of the reinforcing fibers B to be used in accordance with the invention in the fabric F is not employed in the course of consolidation when preimpregnated semifinished fiber products, called prepregs or “preimpregnated fibers”, and no dry semifinished fiber products are used as fabric F. It is frequently the case that no distinction is made in the literature between the terms “consolidation” and “impregnation”, because laminate consolidation and molecular penetration take up only a small portion of the total consolidation time. This proportion of laminate consolidation and molecular penetration in the overall process is usually quantified at an order of magnitude of about 1%. Accordingly, the consolidation process may optionally also be referred to directly as an impregnation process. Short cycle times in the processing are therefore achievable in particular by the use of already preimpregnated semifinished products or fabrics.

In the course of laminate processing, in the consolidation, the surfaces of thermoplastic molding composition as matrix polymer and the reinforcing fibers B of the fabric F are joined to one another at high consolidation pressure and high temperature until complete intimate contact has formed. It is possible here for problematic inclusions of air to arise. It is only by exposure to the consolidation pressure and/or optionally reduced pressure that inclusions of air or other gases can be minimized. The intimate contact that forms in the laminate consolidation means that surface roughness in the joining partners, the matrix polymer and fabric here, are ideally evened out in order that contact is also possible over the entire surface area. Good contact between the joining partners is important since a mechanically durable bond can be created only in the contact regions. Although complete intimate contact could also be achieved with low consolidation pressures, this would extend processing times.

It is only then that the molecular penetration of the fabric F commences in the regions where intimate contact of matrix polymer and fabric F has already formed. As a result of the thermal activation and the associated elevated mobility of the molecules in the matrix, in the molecular penetration, there is interdiffusion of polymer chains into adjacent plies, as a result of which the chain ends of the polymer of the thermoplastic molding composition which is to be used as matrix can form new entanglements and loops with chains of the polymer(s) in the adjacent ply.

The molecular penetration as a result of the diffusion of polymer chains and hence the formation of autohesion is not only time-dependent; it generally also requires flow effects as a driving force, in particular microscale flow movements owing to the consolidation pressure applied. On completion of molecular penetration, the laminate is cooled down in the last step and hence becomes dimensionally stable (solidification).

The resultant pore volume minimized by the application of the consolidation pressure is then essentially maintained at the end of the consolidation phase because of the cooling.

But process-related, thermally induced intrinsic stresses and deformations can then also remain frozen in the fiber composite material. It is likewise important that amorphous thermoplastics, on cooling, retain that molecular orientation that they last assumed in the course of diffusion, while semicrystalline thermoplastics recrystallize from the molten state in the course of cooling. In different cases, it is also the cooling rate that determines the degree of crystallization and the formation of spherulites in process step iv). The degree of crystallization is the proportion of the thermoplastic molecular structure which is in crystalline form. The mechanical and chemical properties (solvent stability etc.) of compositions of partly crystalline thermoplastics are ultimately essentially dependent thereon. The consolidation of thermoplastic materials that are to be used as matrix M in accordance with the invention is thus a process which is nonlinear to a high degree, since it includes the different physical processes mentioned that occur simultaneously to some degree. These processes have a major influence on the ultimate composite quality and hence on the fiber composite material to be produced in accordance with the invention.

Insufficient consolidation can thus have knock-on effects such as trapped pores, intrinsic stresses, deformations, especially distortion, and in some cases premature mechanical failure of the fiber composite material. In order to enable an exact prediction with regard to consolidation, meaningful models for the processes that proceed here are therefore indispensable. Such process models give an input-output relationship between the process parameters and the quality of the molded article T to be manufactured from a fiber composite material to be produced in accordance with the invention, which can reduce costly “trial-and-error” optimizations on the technical equipment to be used in accordance with the invention. A reliable prediction obtained from the simulation as to the quality of a molded article T thus offers an effective pathway to optimization of process step iv) or process steps (iv) to (vi). It can thus be ascertained whether the consolidation quality meets the standards applied to the molded article F to be manufactured. A complete simulation of the consolidation process thus takes account of laminate consolidation, the compaction of the pores, geometric deformation, molecular penetration, thermal degradation, crystallization, and intrinsic stresses and distortion. Mathematical models cannot fully replace physical experiments, but in combination they permit a simple parameter study that gives process-essential information that can otherwise be measured directly only with great difficulty, if at all, and in a time-consuming manner.

Process steps iv) and v), especially the consolidation, are conducted at temperatures of at least 200° C., preferably at temperatures of at least 250° C. and more preferably at temperatures of at least 300° C.

Process steps iv) and v), especially the consolidation, are conducted at pressures in the range from 1 bar to 1000 bar, preferably in the range from 5 bar to 500 bar, more preferably in the range from 10 bar to 50 bar.

Process steps iv) and v) are preferably conducted with a dwell time over a period from 1 to 60 seconds.

The process of the invention is preferably conducted with a dwell time during process steps ii) to v) of not more than 10 minutes at temperatures of at least 200° C., preferably of not more than 5 minutes, more preferably of not more than 2 minutes and especially preferably of not more than 1 minute. For higher temperatures, correspondingly short dwell times are applicable, which must be selected by the person skilled in the art depending on the thermoplastic to be used in each case.

The polar groups at the surface of the reinforcing fibers B that have been treated with a silane size are important for the reaction of the chemically reactive functionalities of the thermoplastic molding composition A in the matrix M with the reinforcing fibers B that sets in in process step v).

The size applied to the reinforcing fibers for this purpose is an impregnation liquid which is applied to the reinforcing fibers B, in particular, by spraying or dipping prior to the further processing thereof to give the weave to be used in accordance with the invention. A sized fiber is more supple and more stable to mechanical stress. Without sizing, a warp thread can easily become brittle, and ultimately break, as a result of the constant friction against the weft thread.

In the production of glass fibers, these are preferably pulled from the melt at high speed. The thickness of the fibers is determined here by the size of the nozzles and the draw rate. The hot fibers are cooled by spraying with water and wetted with size by means of a dip roll, and the individual filaments are bundled to rovings immediately thereafter. The size has several functions. The rovings are bonded by the size binder and hence receive sufficient stability against abrasion in transport and against fraying of individual fibers out of the roving or fracture. Since the size usually contains water as thinner, the rovings have to be dried. For this purpose, they are either wound up while wet to give “cakes” and then dried or processed while wet and dried later. The glass fibers thus obtained can then be incorporated into thermoplastics for reinforcement. In general, the proportion by weight of size in the dried glass fiber is in the range from 0.1% to 10% by weight.

### Process Step vi)

In process step vi), the fiber composite material is cooled down, and there are optionally subsequent further process steps.

Further process steps are preferably the production of a molded article T. In a preferred embodiment, the process then comprises, as a further process step, three-dimensional shaping to a molded article T.

The three-dimensional shaping can be effected in a desired manner, for instance by mechanical shaping by means of a shaping body, which may also be an embossed drum. Preferably, the cooled fiber composite material obtained by process step vi) is finished in a further process step, especially by means of conventional cutting methods, preferably shear cutting, waterjet cutting, laser cutting or ultrasound cutting, then heated to a temperature such that the fiber composite material becomes shapeable and the thermoplastic molding composition A is in (partly) molten form and can be shaped in the shaping body, especially a two-part steel mold. Alternatively or additionally, cold forming of a cured fiber composite material is also possible.

Preferably, at the end of the process, after process step vi), a (largely) solid fiber composite material sheet is obtained.

Further process steps or even cooling under elevated pressure can be effected at a later juncture or elsewhere. Optionally, the molded article T may be subjected to further processing, especially deburring, polishing or coloring.

The process of the invention comprising process steps i) to vi) can be conducted continuously, semicontinuously or batchwise. In a preferred embodiment, the process is conducted as a continuous process, especially as a continuous process for producing smooth or three-dimensional fiber composite material sheets.

Alternatively, it is also possible to produce molded articles T in a semi- or discontinuous fashion. In the case of fiber composite materials based on an amorphous thermoplastic matrix M, these may be provided with fins in an injection molding process, or be laminated (welded) as outer layers onto a foamed thermoplastic core or onto a honeycomb core. An improvement in component stiffness as a result of fins (formation of a finned structure) is explained by the increase in area moment of inertia. In general, optimal fin dimensions include production-related, esthetic and design considerations.

In a particularly preferred embodiment, the present invention relates to the process of the invention for production of a thermoplastic fiber composite material, wherein component A is produced from 90% to 99.7% polypropylene and 0.1% to 10% maleic anhydride, where the fabric F is a weave and the dwell time for production of the fiber composite material at temperatures of at least 150° C. is not more than 10 minutes.

The invention preferably provides a process for producing a fiber composite material comprising a thermoplastic molding composition A as polymer matrix M, reinforcing fibers B, comprising the steps of
i) providing at least one fabric F in the form of a weave composed of reinforcing fibers B treated with silane size,
ii) providing a thermoplastic molding composition A that serves as matrix M, having at least 0.3 mol %, based on component A, of a chemically reactive functionality in the form of functional monomers,
iii) optionally incorporating at least one additive C into the thermoplastic molding composition A,
iv) introducing the thermoplastic molding composition A that serves as matrix M into the at least one fabric F by embedding the thermoplastic molding composition A into the reinforcing fibers B by means of a relative movement in which the reinforcing fibers B remain immobile apart from a continuous or discontinuous one-dimensional production feed, and consolidating this composite composed of at least one fabric F and the matrix M,
v) reacting the chemically reactive functionalities of the thermoplastic molding composition A with the polar groups at the surface of the reinforcing fibers B that have been treated with a silane size,
vi) cooling the fiber composite material, and optionally further process steps,
wherein the chemically reactive functionality of the thermoplastic molding composition A is based on maleic anhydride, and steps iv) to vi) are conducted at a temperature of at least 150° C., and steps v) to vi) are conducted by pressing under elevated pressure, and the thermoplastic molding composition contains 90% to 99.7% by weight of polypropylene and 0.1% to 10% by weight of maleic anhydride, and also 0% to 40% by weight, preferably 0.1% to 25% by weight, of at least one additive C.

For 10% to 95% by weight of the thermoplastic molding composition A, preference is given to using 5% to 90% of the fabric F composed of reinforcing fibers B.

In a further embodiment, further groups of reinforcing fibers B are coupled to the matrix M via further different fiber-matrix adhesions. If three or more groups of reinforcing fibers B with different fiber-matrix adhesions are used, the behavior of the fiber composite material can further be influenced in a controlled and highly individual manner, and adjusted to the respective use of the fiber composite material. It is possible here for different fiber types or identical fiber types to be used in each case.

It is likewise possible for warp and weft threads to consist of different reinforcing fibers and/or to differ in thickness. In addition, the warp and weft threads may have been treated with different size or different concentrations of the size.

Groups of reinforcing fibers B may each have been treated with different adhesion promoter compositions that bring about the different fiber-matrix adhesions. The different compositions may differ exclusively in the concentrations or else have other compositions. What is important is that the different adhesion promoter compositions establish significantly different fiber-matrix adhesions.

The invention is described in detail in the examples, figures and claims that follow.

### FIGURES

FIG. 1 shows a fiber composite material (1) that has been obtained by the process of the invention. The length of the fiber composite material (1) is the extent in direction (2), where (2) is simultaneously the main direction of the continuous fibers used in the fabric F. (3a) and (3b) are examples of the progression of a continuous fiber that moves within the window (4). The fiber composite material (1) obtainable by the process of the invention is characterized by the height of the window (4) of not more than 15%, more preferably of not more than 5%, of the length (2) of the fiber composite material (1).

FIG. 2 shows a fabric F that has typical fiber distortion as a result of relative movements of the fibers.

FIG. 3 shows a fiber composite material obtainable in accordance with the invention, in which the relative movements of the reinforcing fibers B of the fabric F have been prevented by embedding the thermoplastic molding composition into the reinforcing fibers by a relative movement in which the reinforcing fibers B remained immobile apart from a one-dimensional production feed, and consolidating this composite.

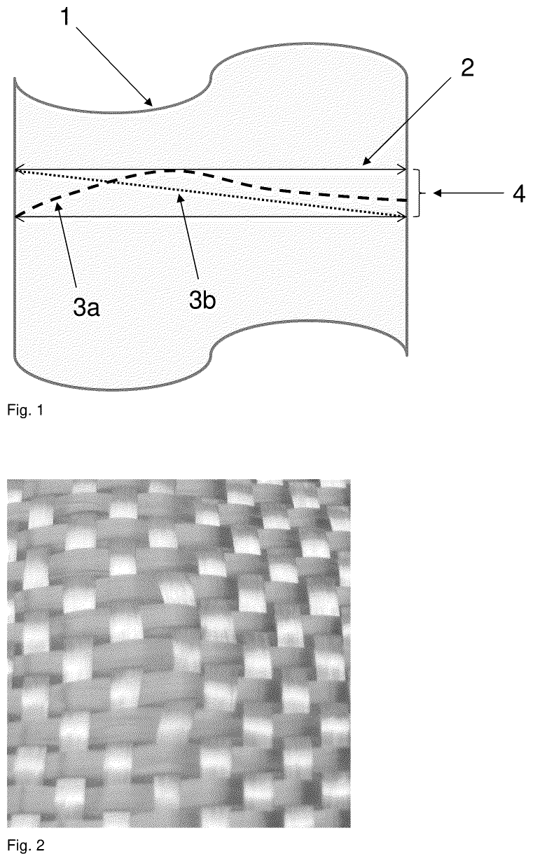

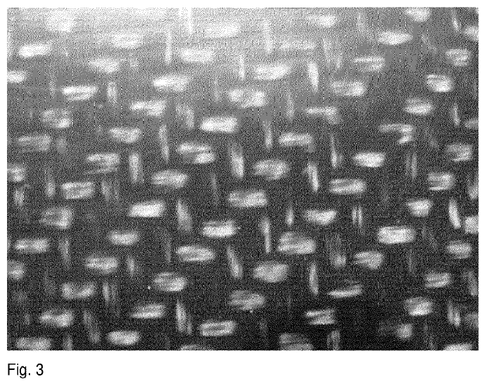

### EXAMPLES

The process of the invention can be performed on a double-belt, interval or static press which is capable of quasi-continuously producing a fiber/film composite from polymer film, melt or powder.
Producible laminate thickness: 0.1 to 15.0 mm
Output: 0.1-1000 m/h, depending on quality and component thickness
Mold pressure: press unit 2 to 60 bar, infinitely adjustable for minimum and maximum mold size (optional)
Mold temperature control: at least one heating zone and at least one cooling zone
Mold temperature: up to 500° C.
Flexural strength was determined to DIN 14125:2011-05 by the three-point bending test or four-point bending test.
See: https://de.wikipedia.org/wiki/Biegefestigkeit

### Components:

A1: polypropylene having a melt volume flow rate (MVR) of 100 cm³/10 min at 230° C./2.16 kg (measured to ISO1133).
A2: maleic anhydride (MA)
A3: mixture of A1 and A2, concentration of functional groups: 3% MA
B1: 2/2 glass fiber twill weave with basis weight=about 600 g/m², weft+warp=1200tex [for example GW123-580K2 from P-D Glasseiden GmbH]

The combination of A1 and B1 and of A3 and B1 is compared in Tab. 1 with regard to the flexural strength achieved. Both combinations were produced with identical processing parameters (pressure, time & temperature). Flexural stiffness is a characteristic with which the quality of the fiber-matrix adhesion and hence the mechanical component quality is assessed. In the case of combinations A1+B1 and A3a+B1a, the tested sheets were produced on a static press, with processing of the reinforcing fibers according to the prior art and hence in a non-distortion-free manner (indicated by “a”). The A3b+B1b combination was produced by a production technique which, according to process step iv) of the process hereby claimed, ensured the distortion-free state of the reinforcing fibers (indicated by “b”).

TABLE 1

| | Flexural |
|---|---|
| | strength |
| Combination | (normalized) |
| A1 + B1 | 100% |
| A3a + B1a | 111% |
| A3b + B1b | 126% |

It was found that the process of the invention could achieve a fiber composite (material) which, in terms of its flexural strength, was superior by 26% to a fiber composite (material) based on the same matrix and the same reinforcing fibers, but produced not with process step iv) but by the process in EP 3 286 258 B1.

### Optional Further Processing

It has also been shown experimentally that the fiber composite materials obtained by the process of the invention had good formability to three-dimensional semifinished products, for example to half shell-shaped semifinished products. It was additionally found that the fiber composite materials obtained were printable and laminatable.

### Summary of the Experimental Results

The evaluation in the context of the present invention showed that fiber composite materials of improved flexural strength, i.e. organosheets and semifinished products producible therefrom, were producible reproducibly by process step iv). Fiber composites/fiber composite materials according to the invention can be produced either in colorless or colored form. The fiber composites/fiber composite materials additionally showed good to very good optical, tactile and mechanical properties, especially with regard to their flexural strength. Fiber distortion that typically occurs in the fabric F could be successfully prevented by the production process of the invention, as a result of which the fiber composite (material) had only minor fiber distortion. The fiber composites/fiber composite materials obtainable in accordance with the invention were producible in a semiautomatic or fully automatic manner by means of a continuous process. The fiber composite/fiber composite materials (organosheets) obtainable in accordance with the invention had good formability to three-dimensional semifinished products.

1. A process for producing a fiber composite material comprising a thermoplastic molding composition A as polymer matrix M, reinforcing fibers B, comprising the steps of
i) providing at least one fabric F in the form of a weave composed of reinforcing fibers B treated with a silane size,
ii) providing a thermoplastic molding composition A that serves as matrix M, having at least 0.3 mol %, based on component A, of a chemically reactive functionality in the form of functional monomers,
iii) optionally incorporating at least one additive C into the thermoplastic molding composition A,
iv) introducing the thermoplastic molding composition A that serves as matrix M into the at least one fabric F by embedding the thermoplastic molding composition A into the reinforcing fibers B by means of a relative movement in which the reinforcing fibers B remain immobile apart from a continuous or discontinuous one-dimensional production feed, and consolidating this composite composed of at least one fabric F and the matrix M,
v) reacting the chemically reactive functionalities of the thermoplastic molding composition A with the polar groups at the surface of the reinforcing fibers B that have been treated with the silane size,
vi) cooling the fiber composite material, and optionally further process steps,
wherein the chemically reactive functionality of the thermoplastic molding composition A is based on components selected from the group of maleic anhydride, N-phenylmaleimide, and glycidyl (meth)acrylate, and steps iv) to vi) are conducted at a temperature of at least 150° C., and steps v) to vi) by pressing under elevated pressure.

2. The process for producing a thermoplastic fiber composite material as claimed in claim 1, characterized in that the thermoplastic molding composition A is based on amorphous or semicrystalline plastic.

3. The process for producing a thermoplastic fiber composite material as claimed in claim 2, characterized in that the thermoplastic molding composition A is based on at least one polymer from the group of polyolefins, polyamides, thermoplastic elastomers, polycarbonates, polybutadiene terephthalates, polylactides, polyphenylene sulfides and styrene copolymers.

4. The process for producing a thermoplastic fiber composite material as claimed in claim 3, characterized in that the polyolefin used is polypropylene.

5. The process for producing a thermoplastic fiber composite material as claimed in claim 1, characterized in that reinforcing fibers B treated with a silane size are used.

6. The process for producing a thermoplastic fiber composite material as claimed in claim 5, characterized in that reinforcing fibers B used are glass fibers.

7. The process for producing a thermoplastic fiber composite material as claimed in claim 6, characterized in that the glass fibers used as reinforcing fibers B have silanol groups on the surface as a chemically reactive functionality.

8. The process for producing a thermoplastic fiber composite material as claimed in claim 1, characterized in that the process, especially process steps iv) and v) or optionally also process step vi), is conducted on a double belt press, interval heating press or on a static press.

9. The process for producing a thermoplastic fiber composite material as claimed in claim 1, characterized in that the temperature in the production of the fiber composite material is at least 150° C., preferably at least 200° C. and more preferably at least 250° C.

10. The process for producing a thermoplastic fiber composite material as claimed in claim 1, characterized in that the dwell time in the production of the fiber composite material at temperatures of at least 200° C. is not more than 10 minutes, preferably not more than 5 minutes, more preferably not more than 2 minutes and in particular not more than 1 minute.

11. The process for producing a thermoplastic fiber composite material as claimed in claim 1, characterized in that the relative movement of the thermoplastic molding composition A in relation to the reinforcing fibers B is achieved by the fixing of the reinforcing fibers B in the direction of relative movement.

12. The process for producing a thermoplastic fiber composite material as claimed in claim 11, characterized in that the fixing of the reinforcing fibers B upstream and downstream of the region in which the movement of the thermoplastic molding composition A is created by a surface pressure >10 bar at a temperature of at least 10° C. above the crystallite melting temperature or glass transition temperature in the case of amorphous thermoplastics is effected by means of mechanical clamping, winding or with the aid of securing elements, and this hold is maintained by application of opposing force under constant strain.

13. The process for producing a thermoplastic fiber composite material as claimed in claim 11, characterized in that the reinforcing fibers B are fixed in position such that the strain in longitudinal direction prevents movement in any spatial direction.

14. The process for producing a thermoplastic fiber composite material as claimed in claim 1, characterized in that the reinforcing fibers B in the form of weaves are fixed and kept under tension by an automatic draw system in roll form on retarded unwinding drums upstream of the region of application of temperature and pressure, and as a consolidated stack downstream of the region of application of temperature and pressure.

15. The process for producing a thermoplastic fiber composite material as claimed in claim 1, characterized in that the chemically reactive functionality of the thermoplastic molding composition A is based on maleic anhydride, and steps iv) to vi) are conducted at a temperature of at least 150° C., and steps v) to vi) are conducted by pressing under elevated pressure, and the thermoplastic molding composition contains 90% to 99.7% by weight of polypropylene and 0.1% to 10% by weight of maleic anhydride, and also 0% to 40% by weight, preferably 0.1% to 25% by weight, of at least one additive C.
